(19) United States
(12) Patent Application Publication
(10) Pub. No.: US 2019/0203926 A1
(43) Pub. Date: Jul. 4, 2019

(54) FLAMELESS CANDLE WITH INTEGRATED FOUNTAIN DEVICE

(71) Applicant: MOU-LI LIN, TAINAN CITY (TW)

(72) Inventor: MOU-LI LIN, TAINAN CITY (TW)

(21) Appl. No.: 15/860,803

(22) Filed: Jan. 3, 2018

(51) Int. Cl. F21V 33/00; B05B 17/08; F21S 6/00; F21S 10/04

(52) U.S. Cl. CPC F21V 33/0028; B05B 17/08; F21W 2121/02; F21S 10/04; F21S 6/001

(57) ABSTRACT

A flameless candle with integrated fountain device includes a container, having an accommodation space therein, a bottom of the container having a bottom plate adjacent to the accommodation space, an opening being disposed opposite the bottom plate and communicated with the accommodation space; a tube, located in the accommodation space, the tube having an inlet end and an outlet end, the outlet end being relatively higher than the inlet end; a pump motor, communicated with the accommodation space and the inlet end of the tube; a light-emitting member, configured to emit light to pass through the opening of the accommodation space; and an atomizer, adjacent to the outlet end of the tube. In addition to water flow and a change of light and shadow, the flameless candle also provides a misty effect generated by the atomizer.

### FIELD OF THE INVENTION

The present invention relates to a flameless candle with integrated fountain device, and more particularly to a flameless candle with integrated fountain device which has a misty effect provided by an atomizer in addition to water flow and a change of light and shadow.

### BACKGROUND OF THE INVENTION

In the past, candles are used as a lighting source. In these days, candles become a lighting apparatus to increase joy of life, such as table lights, display lights and so on. A flameless candle includes a light-emitting member and a candle-shaped shell. The flameless candle is environmentally friendly and saves costs.

A flameless candle structure is disclosed in U.S. Patent Application Publication No. 20130223043 titled “Flameless Candle with Integrated Fountain”, which is provided with a light-emitting member to emit light. The light penetrates flowing water to form a change of light and shadow.

The conventional flameless candle only generates water flow and a change of light and shadow. Consumers are always seeking new products. Therefore, the inventor hopes that flameless candles will not only have the sound effect of water flow and the visual effect of changes of light and shadow but also have visual and tactile feeling. Accordingly, the inventor of the present invention has devoted himself based on his many years of practical experiences to solve these problems.

### SUMMARY OF THE INVENTION

In view of the shortcomings of the prior art, the primary object of the present invention is to provide a flameless candle with integrated fountain device.

According to one aspect of the present invention, a flameless candle with integrated fountain device is provided. The flameless candle with integrated fountain device comprises a container, having an accommodation space therein; a tube, placed in the container; a light-emitting member, configured to emit light to pass through the container; and an atomizer, intersecting the accommodation space.

According to another aspect of the present invention, a flameless candle with integrated fountain device is provided. The flameless candle with integrated fountain device comprises a container, having an accommodation space therein, a bottom of the container having a bottom plate adjacent to the accommodation space, an opening being disposed opposite the bottom plate and communicated with the accommodation space; a tube, located in the accommodation space, the tube having an inlet end and an outlet end, the outlet end being relatively higher than the inlet end; a pump motor, communicated with the accommodation space and the inlet end of the tube; a light-emitting member, configured to emit light to pass through the opening of the accommodation space; and an atomizer, adjacent to the outlet end of the tube and intersecting the accommodation space through the outlet end.

Preferably, the bottom plate of the container has an inner surface and an outer surface opposite the inner surface. The light-emitting member is disposed on the outer surface of the bottom plate.

Preferably, the flameless candle with integrated fountain device further comprises a power supply unit. The power supply unit is electrically connected to the pump motor, the light-emitting member and the atomizer.

Preferably, the flameless candle with integrated fountain device further comprises an outer cylinder. The power supply unit is disposed in the outer cylinder. The container is disposed in the outer cylinder and located above the power supply unit. Preferably, the flameless candle with integrated fountain device further comprises a first accommodation tube disposed in the accommodation space. A guide wire of the atomizer extends into the first accommodation tube. The first accommodation tube has a through hole thereon. The bottom of the container is formed with a first hole and a second hole. The pump motor is connected to the power supply unit through the first hole. A second accommodation tube is in communication with the second hole. The guide wire of the atomizer is inserted through the through hole of the first accommodation tube into the second accommodation tube and connected to the power supply unit through the second hole. Preferably, the first accommodation tube is integrally formed with the tube.

Preferably, the outlet end of the tube is connected to a saucer. The saucer extends an annular side wall to surround an accommodation area. The accommodation area is in communication with the outlet end of the tube. The atomizer is disposed in the accommodation area.

Preferably, the annular side wall is provided with at least one aperture.

According to the foregoing technical features, the present invention can achieve the following effects:

1. In addition to water flow and a change of light and shadow, the flameless candle of the present invention provides a misty effect. When the viewer approaches the flameless candle, he/she may feel the mist. The flameless candle of the present invention achieves visual, auditory and tactile feeling.

2. The tube layout of the present invention allows the overall structure to be manufactured easily, so that the price of the product is competitive.

### BRIEF DESCRIPTION OF THE DRAWINGS

FIG. 1 is a structural schematic view of the present invention, illustrating the route of the water flow of the present invention;

FIG. 2 is a structural schematic view of the present invention, illustrating the layout of the tube of the present invention; and

FIG. 3 is a schematic view of the present invention when in use, illustrating the water flow, the change of light and shadow, and misty effect.

### DETAILED DESCRIPTION OF THE PREFERRED EMBODIMENTS

Embodiments of the present invention will now be described, by way of example only, with reference to the accompanying drawings.

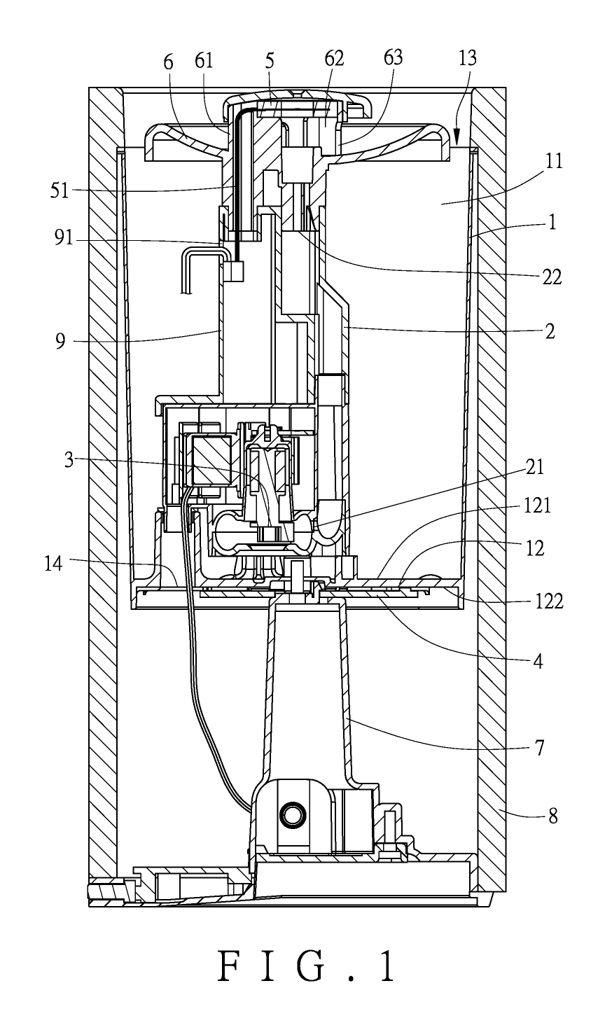

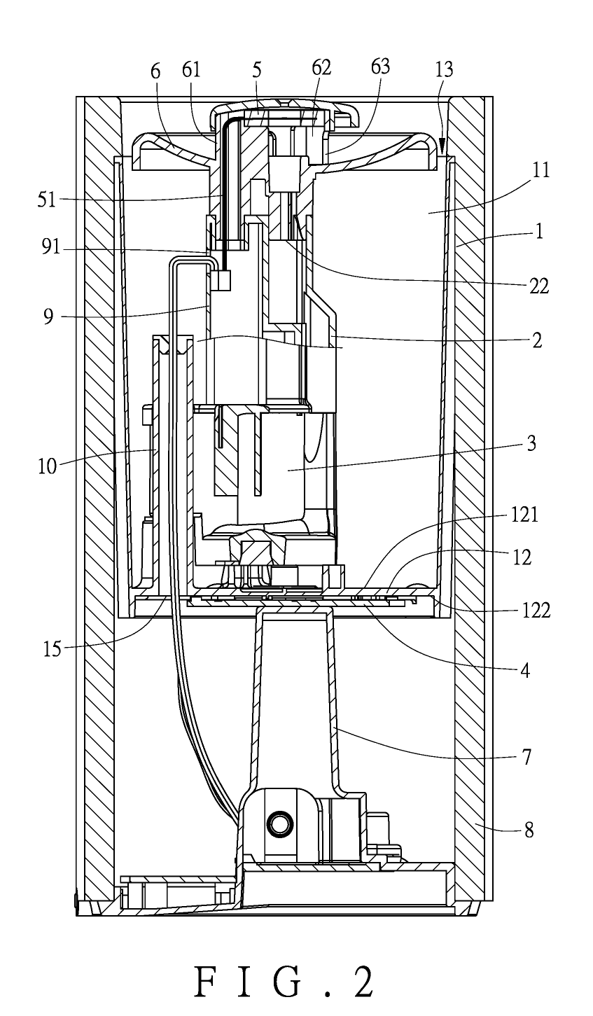

Referring to FIG. 1 and FIG. 2, a flameless candle with integrated fountain device in accordance with an embodiment of the present invention comprises a container (1), a tube (2), a pump motor (3), a light-emitting member (4), an atomizer (5), and a power supply unit (6). The container (1) is translucent or transparent. The container (1) has an accommodation space (11) therein. The bottom of the container (1) has a bottom plate (12) adjacent to the accommodation space (11). An opening (13) is disposed opposite the bottom plate (12) and communicated with the accommodation space (11). The bottom plate (12) has an inner surface (121) and an outer surface (122) opposite the inner surface (121). The tube (2) is located in the accommodation space (11). The tube (2) has an inlet end (21) and an outlet end (22). The outlet end (22) is relatively higher than the inlet end (21). Preferably, the outlet end (22) is close to the opening (13) of the accommodation space (11) and is located at a central position. The pump motor (3) is in communication with the accommodation space (11) and the inlet end (21) of the tube (2). Preferably, the inlet end (21) is close to the bottom plate (12) of the accommodation space (11). The light-emitting member (4) is configured to emit light to pass through the opening (13) of the accommodation space (11). The light-emitting member (4) is disposed on the outer surface (122) of the bottom plate (12). The atomizer (5) is adjacent to the outlet end (22) the tube (2). The outlet end (22) is connected to a saucer (6). The saucer (6) extends an annular side wall (61) to surround an accommodation area (62). The accommodation area (62) is in communication with the outlet end (22) of the tube (2). The atomizer (5) is disposed in the accommodation area (62). The annular side wall (61) is provided with at least one aperture (63). The power supply unit (7) is electrically connected to the pump motor (3), the light-emitting member (4), and the atomizer (5). Furthermore, the present invention further comprises an outer cylinder (8) which is translucent or transparent. The power supply unit (7) is disposed in the outer cylinder (8). The container (1) is disposed in the outer cylinder (8) and located above the power supply unit (7). Wherein, a first accommodation tube (9) is provided in the accommodation space (11). A guide wire (51) of the atomizer (5) extends into the first accommodation tube (9). The first accommodation tube (9) has a through hole (91) thereon. The bottom of the container (1) is formed with a first hole (14) and a second hole (15). The first hole (14) and the second hole (15) are provided with waterproof gaskets. The pump motor (3) is connected to the power supply unit (7) through the first hole (14). A second accommodation tube (10) is in communication with the second hole (15). The guide wire (51) of the atomizer (5) is inserted through the through hole (91) of the first accommodation tube (9) into the second accommodation tube (10) and is connected to the power supply unit (7) through the second hole (15). The first accommodation tube (9) is integrally formed with the tube (2).

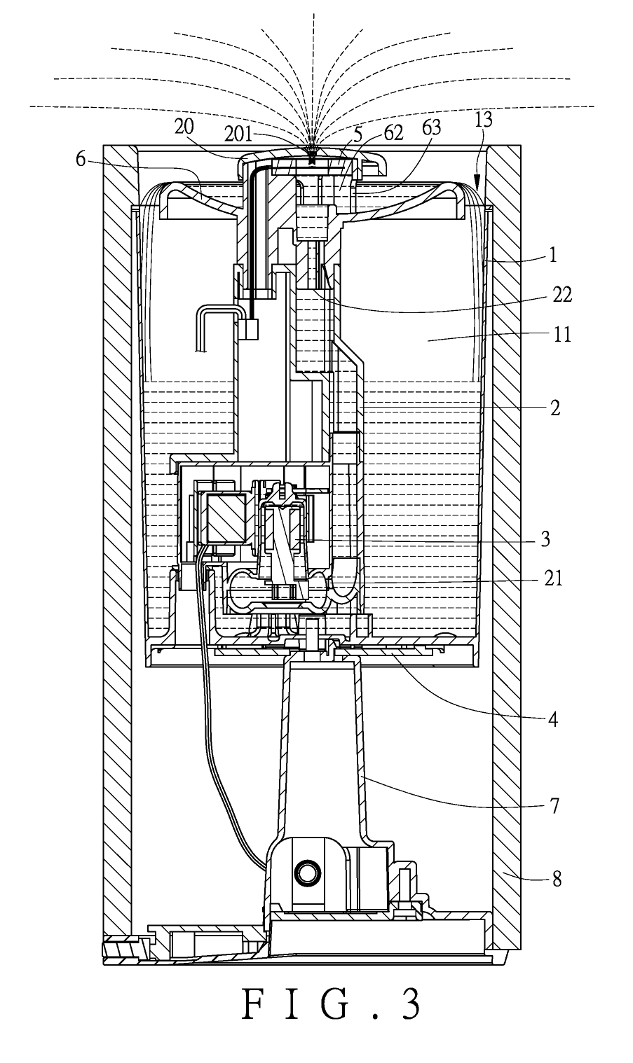

Referring to FIG. 3, when in use, the accommodation space (11) of the container (1) is filled with a liquid such as water, and then an additive such as an essence or pigment is added to the water to increase the fragrance of the water or to change the color of the water. The power supply unit (7) is then turned on to actuate the pump motor (3), the light-emitting member (4) and the atomizer (5).

The light emitted from the light-emitting member (4) may penetrate through the transparent or translucent container (1) and the outer cylinder (8) in addition to the light passing through the opening (13) of the accommodation space (11). When the light is emitted, the light passes through the water flow because the accommodation space (11) of the container (1) is filled with water. Through the flowing characteristic of the water flow, the emitted light exhibits a change of light and shadow.

In addition, the water in the accommodation space (11) is pumped by the pump motor (3) to enter the tube (2) through the inlet end (21) of the tube (2) and then drain through the outlet end (22) of the tube (2). Wherein, because the outlet end (22) is connected to the saucer (6), the saucer (6) is communicated with the outlet end (22) through the accommodation area (62). The annular side wall (61) surrounding the accommodation area (62) has the aperture (63) so that the water enters the accommodation area (62), and part of the water flows into the saucer (6) from the aperture (63) of the annular side wall (61). When the saucer (6) is filled with water, the water flows back into the accommodation space (11), thereby forming a waterfall effect.

It should be noted that when the water flows into the accommodation area (62), part of the water is atomized into mist by the oscillating effect of the atomizer (5), thereby forming a misty effect. A decorative tray (20) may be installed above the atomizer (5). The decorative tray (20) is formed with a spray hole (201), so that the atomized mist can be sprayed out from the spray hole (201) to create the effect that the underground hot spring gushes out with steam from the ground. However, it should be noted that the atomizer may be directly placed in the accommodation space or other places, as long as it can be in contact with water to generate mist through oscillation, all of which are protected by the present invention.

Through the cooperation of the light passing through the water flow to present a change of light and shadow, the water flowing back into the accommodation space (11) from the saucer (6) to form a waterfall effect and the mist sprayed out from the spray hole (201) of the decorative tray (20) to create the effect that the underground hot spring gushes out with steam, the flameless candle of the present invention achieves visual, auditory and tactile feeling.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A flameless candle with integrated fountain device, comprising:
a container, having an accommodation space therein, a bottom of the container having a bottom plate adjacent to the accommodation space, an opening being disposed opposite the bottom plate and communicated with the accommodation space;
a tube, located in the accommodation space, the tube having an inlet end and an outlet end, the outlet end being relatively higher than the inlet end;
a pump motor, communicated with the accommodation space and the inlet end of the tube;
a light-emitting member, configured to emit light to pass through the opening of the accommodation space; and
an atomizer, intersecting the accommodation space.

2. The flameless candle with integrated fountain device as claimed in claim 1, wherein the bottom plate of the container has an inner surface and an outer surface opposite the inner surface, and the light-emitting member is disposed on the outer surface of the bottom plate.

3. The flameless candle with integrated fountain device as claimed in claim 1, further comprising a power supply unit, the power supply unit being electrically connected to the pump motor, the light-emitting member and the atomizer.

4. The flameless candle with integrated fountain device as claimed in claim 3, further comprising an outer cylinder, the power supply unit being disposed in the outer cylinder, the container being disposed in the outer cylinder and located above the power supply unit.

5. The flameless candle with integrated fountain device as claimed in claim 4, further comprising a first accommodation tube disposed in the accommodation space, a guide wire of the atomizer extending into the first accommodation tube, the first accommodation tube having a through hole thereon, the bottom of the container being formed with a first hole and a second hole, the pump motor being connected to the power supply unit through the first hole, a second accommodation tube being in communication with the second hole, the guide wire of the atomizer being inserted through the through hole of the first accommodation tube into the second accommodation tube and connected to the power supply unit through the second hole.

6. The flameless candle with integrated fountain device as claimed in claim 5, wherein the first accommodation tube is integrally formed with the tube.

7. The flameless candle with integrated fountain device as claimed in claim 1, wherein the outlet end of the tube is connected to a saucer, the saucer extends an annular side wall to surround an accommodation area, the accommodation area is in communication with the outlet end of the tube, and the atomizer is disposed in the accommodation area.

8. The flameless candle with integrated fountain device as claimed in claim 7, wherein the annular side wall is provided with at least one aperture.

9. The flameless candle with integrated fountain device as claimed in claim 1, wherein the atomizer is adjacent to the outlet end of the tube and intersects the accommodation space through the outlet end.

10. A flameless candle with integrated fountain device, comprising:
a container, having an accommodation space therein;
a tube, placed in the container;
a light-emitting member, configured to emit light to pass through the container; and
an atomizer, intersecting the accommodation space.
